(19) United States
(12) Patent Application Publication
(10) Pub. No.: US 2024/0286154 A1
(43) Pub. Date: Aug. 29, 2024

(54) SPRAY SYSTEM FOR DISPENSING AND MIXING MULTI-PART LIQUIDS

(71) Applicant: Spraying Systems Co., Wheaton, IL (US)

(72) Inventor: Stéphane Pelletier, St-Alexis de Montcalm (CA)

(21) Appl. No.: 18/589,846

(22) Filed: Feb. 28, 2024

Related U.S. Application Data
(60) Provisional application No. 63/448,786, filed on Feb. 28, 2023.

(51) Int. Cl. B05B 7/08

(52) U.S. Cl. CPC B05B 7/0846

(57) ABSTRACT

A spray system for mixing multi-part liquids and spraying a mixed liquid product onto a spray target includes first and second spray nozzles. The first spray nozzle dispenses a first constituent liquid part of the mixed liquid. A second spray nozzle dispenses a second constituent liquid part of the mixed liquid product. The first spray nozzle and the second spray nozzle are oriented relative to each other and the spray target such that the first constituent liquid part and the second constituent liquid part impinge on each other while airborne and prior to reaching the spray target.

### CROSS-REFERENCE TO RELATED APPLICATIONS

This patent application claims the benefit of U.S. Provisional Patent Application No. 63/448,786 filed Feb. 28, 2023, which is incorporated by reference.

### BACKGROUND OF THE INVENTION

Many industrial spraying applications involve the mixing of two-part or multi-part catalyzing liquids such as resins, adhesives, or paints. In the boat building industry, for example, marine grade carpet is glued in place using a two-part adhesive. Typically, the base liquid and catalyst comprising the adhesive is either premixed before it is applied via a spray nozzle or it is mixed within the spray nozzle itself. However, both premixed adhesives or adhesives mixed within the spray nozzle present the potential for unwanted hardening of the adhesive within the spray nozzle or elsewhere in the spray system such as in the fluid feed lines. In many instances, such hardening of the adhesive in the spray equipment necessitates costly repairs and lengthy and inefficient downtime of the adhesive spraying equipment.

### OBJECTS OF THE INVENTION

In view of the foregoing, a general object of the present invention is to provide a spray system that effectively eliminates the possibility of unwanted hardening of multi-part liquids such as adhesives within the spray nozzle or spray apparatus.

A related object of the present invention is to provide a spray system that mixes multi-part liquid spray products after the constituent parts of the liquid are discharged from the spray system.

A further object of the present invention is to provide a spray system for dispensing multi-part liquid spray products that completely and thoroughly mixes the constituent parts of a multi-part liquid spray product after the constituent parts are discharged from the spray system.

Another object of the present invention is to provide a spray system for dispensing multi-part liquid spray products that is capable of discharging precise amounts of constituent parts in order to achieve a desired final liquid spray product.

A more specific object of the present invention is to provide a spray system for dispensing multi-part catalyzed liquid spray products in which a base constituent part fluid is dispensed via a first spray nozzle and an activator or catalyzing constituent part liquid is dispensed via a second spray nozzle.

### BRIEF DESCRIPTION OF THE SEVERAL VIEWS OF THE DRAWINGS

FIG. 1 is a schematic perspective view of an exemplary spray system for dispensing a multi-part liquid spray product according to present invention showing first and second spray nozzles for respectively discharging first and second constituent parts of the liquid spray product and the resultant impinging spray patterns of the first and second spray nozzles.

FIG. 2 is a schematic side view of the spray system of FIG. 1 showing a spray controller, the respective liquid supplies and the impinging spray patterns of the first and second spray nozzles.

### DETAILED DESCRIPTION OF THE INVENTION

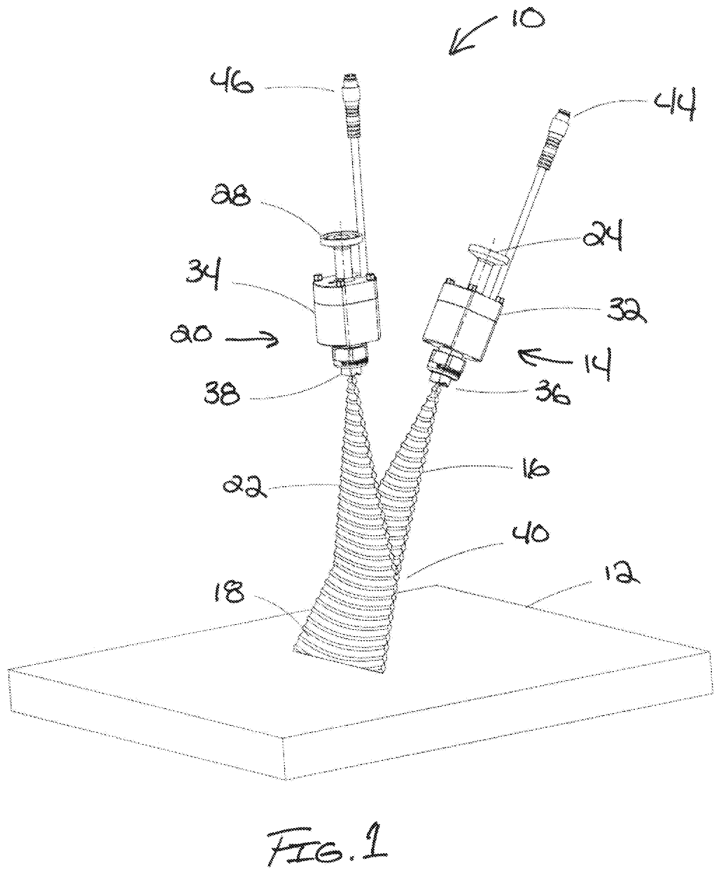

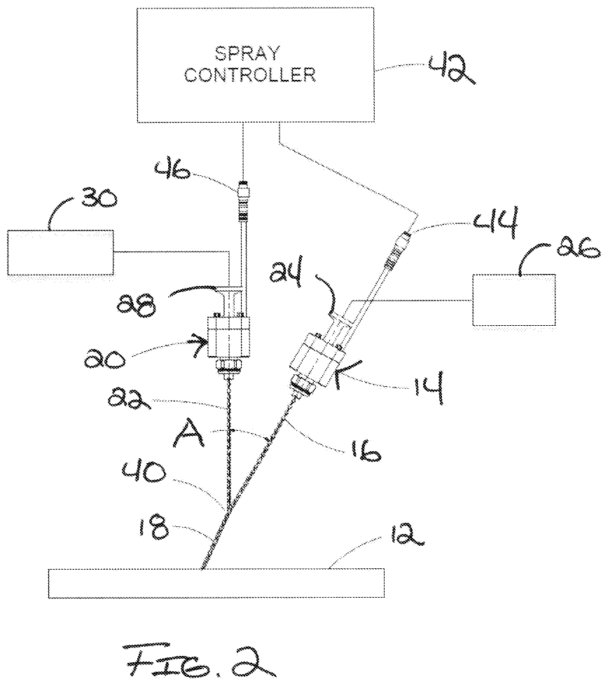

Referring now more particularly to FIGS. 1-2 of the drawings, there is shown an illustrative spray system 10 in accordance with the invention for dispensing a liquid spray product comprising multiple constituent parts that are mixed together to form the final liquid spray product. In this case, the liquid spray product is made of two separate constituent parts, but it should be understood that the spray system 10 of the present invention may be adapted to dispense a liquid spray product with more than two constituent parts. Moreover, while aspects of the invention are illustrated and described in connection with an application in which one constituent part is a base liquid and one constituent part is a catalyzing liquid, it should be understood that the present invention is not limited to any particular type of liquid spray product or particular type of constituent parts. Also, while the present invention is described in connection with spraying the liquid spray product (e.g., an adhesive) onto a substrate 12 (e.g., a carpet), it should be understood that the liquid product may be dispensed in relation to any suitable target.

The illustrative liquid dispensing system 10 includes a first spray nozzle 14 for dispensing a first constituent liquid part 16 of the liquid spray product 18 and a second spray nozzle 20 for dispensing a second constituent liquid part 22 of the liquid spray product 18. In the illustrated embodiment, both the first and second spray nozzles 14, 20 are hydraulic spray nozzles. In particular, as shown in FIG. 2, the first spray nozzle 14 includes a fluid inlet 24 connected to a pressurized first constituent liquid part supply 26 (e.g., a supply of base) and the second spray nozzle 20 includes a fluid inlet 28 connected to a pressurized second constituent liquid part supply 30 (e.g., a supply of catalyst). As shown in FIG. 1, each of the first and second spray nozzles 14, 20 further includes a fluid passage through a respective spray nozzle body 32, 34 that communicates with a respective spray tip 36, 38 at the downstream end of the spray nozzle body. While the illustrated embodiment includes two spray nozzles 14, 20, it should be understood that more spray nozzles could be provided either for providing a final liquid product with more than two constituent parts or where pairs of spray nozzles are arranged in an array in order to cover a relatively larger spray target.

Each of the illustrated first and second spray nozzles 14, 20 is configured to be electrically actuated between an on position in which the respective constituent fluid part 16, 22 is being discharged and an off position in which the spray of liquid is shut off. For example, each of the first and second spray nozzles 14, 20 may include an electric actuator that provides an electromagnetic charge that compresses a spring and lifts a magnetically attracted poppet valve off a valve seat when energized and thereby allows the respective constituent part 16, 22 to discharge through the spray tip 36, 38. As will be appreciated, other electrical actuation configurations could also be used.

To ensure consistency in the mixing of the constituent liquid parts 16, 22, the first and second spray nozzles 14, 20 are arranged, oriented and configured such that the constituent liquid parts 16, 22 impinge while airborne and prior to reaching the target substrate 12. In particular, the first and second constituent liquid parts 16, 22 are discharged in respective spray patterns that collide or impinge while airborne between the spray nozzles 14, 20 and the intended target substrate 12 thereby providing an efficient liquid mix. In this case, the spray tips 36, 38 of the first and second spray nozzles 14, 20 are each configured to produce a flat fan-shaped pattern. With such a spray pattern, the first and second spray nozzles 14, 20 should be arranged and oriented relative to each other such that flat fan spray pattern of the first constituent liquid part 16 and the flat fan spray pattern of the second constituent liquid part 22 impinge at a location 40 where the flat fan spray patterns have substantially matching widths allowing the two fluids to intersect completely at the impingement location 40. According to one embodiment in which a two-part catalyzed liquid product is formed, the impingement of a base fluid and a catalyzing fluid while airborne can facilitate the efficient and complete mixing of a two-part catalyst solution. Additionally, the use of hydraulic spray nozzles as the first and second spray nozzles 14, 20 allows for the production of flat fan spray patterns capable of combining while airborne to produce the necessary mixing of a final multi-part liquid product before it is applied to a target while eliminating unwanted atomization and overspray of the constituent part liquids or the final liquid product.

To direct actuation of the first and second spray nozzles 14, 20 between the on and off positions, the spray system 10 may include a spray controller 42 as shown in FIG. 2. In this case, each of the first and second spray nozzles 14, 20 includes a short whip type electrical connector 44, 46 that is connectable to the spray controller 42. The use of electrically actuated first and second spray nozzles 14, 20 in combination with a spray controller 42 allows each of the first and second spray nozzles 14, 20 to be modulated to very precise application rates of the respective first and second constituent liquid parts 16, 22. Moreover, with such an arrangement, the first and second spray nozzles 14, 20 are able to be modulated by the spray controller 42 independent of one another so that the first and second constituent liquid parts 16, 22 can be set to different application rates. This arrangement provides an efficient and complete mixing of the two constituent parts at a precise desired mixing ratio.

According to one example, the intersection angle A (see FIG. 2) between the flat fan spray pattern of the first constituent liquid part 16 and the flat fan spray pattern of the second constituent liquid part 22 is between about 30 degrees and about 45 degrees to provide a desired mixture of the two parts. The exact intersection angle A may be selected based on the resulting collision of the two flat fan spray patterns and the desire to achieve an unbroken yet completely mixed spray pattern of the final liquid product 18 between the fluid impingement location 40 and the target substrate 12. The pressures of the first and second constituent part liquid supplies 26, 30 will also influence the desired spray pattern intersection angle A. For example, if the first constituent liquid part 16 is a base liquid at about 80 psi and the second constituent liquid part 22 is a catalyzing liquid at about 20 psi, then the intersection angle A can approach about 45 degrees without having a large effect on the resulting vector of the combined final liquid product 18, however if the liquid pressures for the base liquid and the catalyzing liquid are closer to each other a more acute impingement angle A may be desired.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A spray system for mixing multi-part liquids and spraying a mixed liquid product onto a spray target, the spray system comprising:
a first spray nozzle for dispensing a first constituent liquid part of the mixed liquid product in a first spray pattern, the first spray nozzle being actuatable between an on position in which the first constituent part is being dispensed in the first spray pattern and an off position in which the first constituent part is not being dispensed; and
a second spray nozzle for dispensing a second constituent liquid part of the mixed liquid product in a second spray pattern, the second spray nozzle being actuatable between an on position in which the second constituent part is being dispensed in the second spray pattern and an off position in which the second constituent part is not being dispensed;
wherein the first spray nozzle and the second spray nozzle are oriented relative to each other and the spray target such that when the first spray nozzle and the second spray nozzle are in their respective on position the first spray pattern and the second spray pattern impinge on each other while airborne and prior to reaching the spray target.

2. The spray system of claim 1, further including a spray controller in communication with the first spray nozzle and the second spray nozzle, the spray controller configured to modulate movement of the first spray nozzle between the on and the off positions to produce a first application rate and configured to modulate movement of the second spray nozzle between the on and off positions to produce a second application rate.

3. The spray system of claim 2, wherein the spray controller is configured to modulate the first and second spray nozzles such that the first application rate is different than the second application rate.

4. The spray system of claim 2, wherein the first and second spray nozzles are electrically actuated.

5. The spray system of claim 1, wherein the first spray pattern has a flat, fan-shaped configuration and the second spray pattern has a flat, fan-shaped configuration.

6. The spray system of claim 5, wherein the first spray nozzle and the second spray nozzle are oriented relative to each other such that the first spray pattern of the first constituent part impinges on the second spray pattern of the second constituent part at a location wherein the first spray pattern and the second spray pattern have substantially equal widths.

7. The spray system of claim 1, further including a first liquid supply of the first constituent part in fluid communication with the first spray nozzle and a second liquid supply of the second constituent part in fluid communication with the second spray nozzle.

8. The spray system of claim 7, wherein the first and second spray nozzles are oriented relative to each other to define an intersection angle between the first spray pattern and the second spray pattern, the intersection angle being selected based on a first pressure of the first supply and a second pressure of a second supply of the second constituent part to the second spray nozzle.

9. The spray system of claim 8, wherein the intersection angle is about 30 degrees and about 45 degrees.

10. The spray system of claim 1, wherein one of the first and second constituent parts is a catalyst.
